(19) United States
(12) Patent Application Publication
(10) Pub. No.: US 2003/0187735 A1
(43) Pub. Date: Oct. 2, 2003

(54) Life-cycle -based pre-emptive electronic mail generator

(76) Inventor: Pierre Dewis Francois Olivier, Berkeley, CA (US)

Correspondence Address: HEWLETT-PACKARD COMPANY, Intellectual Property Administration, P.O. Box 272400, Fort Collins, CO, 80527-2400, US

(21) Appl. No.: 10/114,377

(22) Filed: Apr. 1, 2002

(51) Int. Cl. G06F 17/60

(52) U.S. Cl. 705/14; 707/104.1

(57) ABSTRACT

One embodiment comprises a method for generating life-cycle-based pre-emptive electronic mail relating to a consumer electronic product. The method determines timing for sending the electronic mail messages using customer data from a customer database and life-cycle events from an event database. Message content for the electronic mail messages is personalized for a customer using the customer data and content from a content database.

Another embodiment comprises an apparatus for generating life-cycle-based pre-emptive electronic mail relating to a consumer electronic product. The apparatus includes interfaces to a customer database, an event database, and a content database. The apparatus uses data from these databases to determine the product life-cycle based timing and personalized content of electronic messages.

### FIELD OF THE INVENTION

The present invention relates in general to electronic communications. More particularly, the present invention relates to electronic communications in relation to consumer electronics.

### DESCRIPTION OF THE BACKGROUND ART

In the consumer electronics industry, end users typically use only a fraction of a product's capabilities and features. For example, a consumer may purchase a digital camera, but only learn how to use 20% of the camera's capabilities and features. The consumer may learn a basic way to take pictures using the camera and one way to download the pictures from the camera to a personal computer. However, the consumer may not learn how to use various other features available. For example, he may not learn how to use the camera to display the pictures directly on a television using a “slide show” type feature of the camera. As another example, he may not learn how to use the camera to record and store audio clips relating to the pictures.

In addition, end users encounter various support issues during ownership and operation of a consumer electronics product. Providing customer support for consumer electronics products can require numerous support personnel and may be a continuing cost after sale of the products.

One prior way to address the above issues is by way of user manuals. User manuals for consumer electronics products are a problematic and disadvantageous way to communicate information about a product's capabilities and features to end users. First, consumers rarely read user manuals in detail, if they read them at all. Second, a user manual may be glanced at by the consumer right after opening the product package, but the user manual is not typically conveniently available to the end user later on. For example, the user manual for the camera may be stored away in a file cabinet or a shoebox, or may have been discarded. Third, user manuals are expensive to print and hence wasteful of paper resources.

Other conventional predecessors to the present invention include informational web sites for consumer products. Such informational web sites serve as passive sources of information. The web sites merely passively wait for a consumer to access the site in search of information.

### SUMMARY OF THE INVENTION

One embodiment of the invention comprises a method for generating life-cycle-based pre-emptive electronic mail relating to a consumer electronic product. The method determines timing for sending the electronic mail messages using customer data from a customer database and life-cycle events from an event database. Message content for the electronic mail messages is personalized for a customer using the customer data and content from a content database.

Another embodiment of the invention comprises an apparatus for generating life-cycle-based pre-emptive electronic mail relating to a consumer electronic product. The apparatus includes interfaces to a customer database, an event database, and a content database. The apparatus uses data from these databases to determine the product life-cycle based timing and personalized content of electronic messages.

### BRIEF DESCRIPTION OF THE DRAWINGS

FIG. 1 is a flow chart depicting a conventional method for providing consumer electronics product information by way of an informational web site.

FIG. 2 is a diagram depicting a conventional system for providing consumer electronics product information by way of an informational web site.

FIG. 3 is a flow chart depicting a method in accordance with an embodiment of the invention.

FIG. 4 is a diagram depicting an apparatus in accordance with an embodiment of the invention.

FIG. 5 is an illustration showing a generated electronic mail message in accordance with an embodiment of the invention.

### DESCRIPTION OF THE SPECIFIC EMBODIMENTS

The present invention distinguishes over previous means, such as user manuals and web sites, by dynamically and intelligently providing product information to customers. The present invention uses gatherable information on product life-cycles to automatically and preemptively inform customers in a timely and appropriate manner, which will help customers to more fully and effectively use the product over part of or the entire product life cycle. Embodiments of the present invention use gatherable information on customer support issues during a product life-cycle to automatically and preemptively inform customers in a timely and appropriate manner about support issues, allowing customer support issues to be dealt with more efficiently and effectively. In addition, embodiments of the present invention inform the customer of related products that can be used with the product, enhancing the use of the product. Further, automatically and pre-emptively informing customers in a timely and appropriate manner reduces the disadvantages of the customer having to proactively and successfully seek out useful and relevant knowledge relating to the product at the appropriate time.

Consumer electronics as used herein means electronic devices used in the home or the office and includes, for example, digital cameras, printers, scanners, computers, servers, televisions, DVD players, fax machines, copiers, personal digital assistants, electronic calendaring devices, calculators, appliances, telephones and audio equipment.

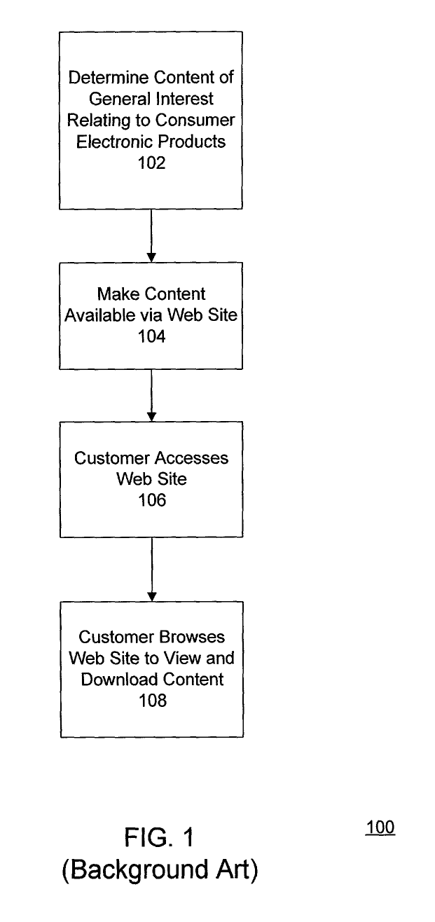

FIG. 1 is a flow chart depicting a conventional method 100 for providing consumer electronics product information by way of an informational web site. The convention method 100 is, of course, only one of the different ways that consumers find out information about consumer electronics products. The conventional method 100 is depicted as four steps.

In a first step 102, the consumer electronics company determines what content might be relevant, useful or interesting to the consumer relating to the product. For example, the consumer electronics company may determine through consumer surveys and other means that consumers will want to know about product features, complementary products, how to use the product, trouble-shooting, and product specifications. The content will typically be broad, extensive or general in nature.

In a second step 104, the consumer electronics company makes the content as determined in step 102 available and accessible through the Internet typically via web pages. The content will typically be organized on the web site categorically and systematically to facilitate the consumer's effort to locate appropriate information. Web sites on products may become extensive and comprehensive if substantial portions of the content as determined in step 102 are included.

In a third step 106, a consumer looking for information on the product locates and accesses the web site. For example, the consumer may be looking to upgrade the product, solving a problem with the product, understanding how to better use the product, finding additional complementary products or add-on devices or software to improve or enhance the product, or seeking supplies for the product. To access the web site, the consumer must be able to locate or otherwise navigate to the web site. For example, the consumer may link to the web site from a related web site of the consumer product company, locate the web site from a search engine or other web navigation method, find the web site address from the user manual or other documentation provided by the consumer product company and manually enter the web site address, or obtain the web site address from a telephone customer service representative and manually enter the web site address.

In a fourth step 108, the consumer browses and reads content on the web site and may download any appropriate content the consumer finds. The content available on the web site may actually be what the consumer is looking for and may be useful to the consumer. For example, the content determined in step 102 may match the information the consumer seeks, the comprehensiveness of the content displayed may provide the extent of information the consumer desires, and the web site may have content in the appropriate language. The consumer may actually be able to locate this relevant content. For instance, the content may be organized and displayed effectively, and the consumer may be skilled and patient enough to locate the content. After locating any relevant content, the consumer may download the information to the consumer's computer for reading on the screen in a different format or for printing.

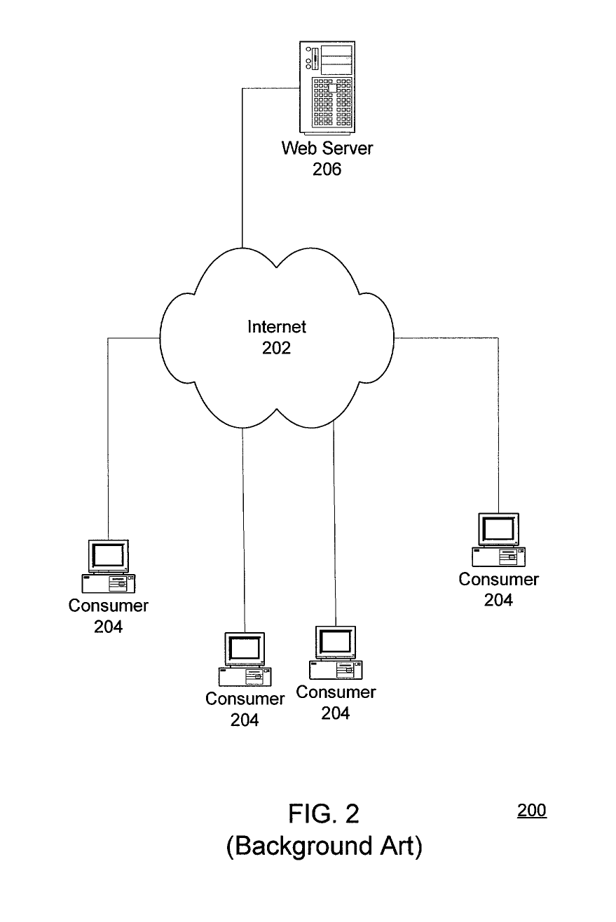

FIG. 2 is a diagram depicting a conventional system for providing consumer electronics product information by way of an informational web site. The web content made available via the web site in step 102 is stored on a web server 206. The web content stored on a web server 206 may change from time to time. When the consumer looks for, locates and accesses the web site in step 104, the consumer 204 connects to the web server 206 through the Internet 202 and downloads the content in the web pages for browsing, reading, and storing in the consumer's computer if appropriate.

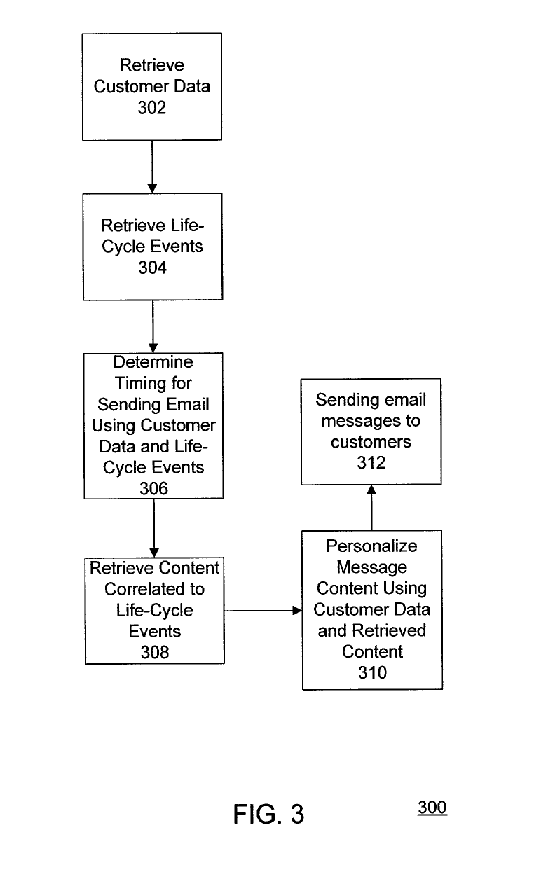

FIG. 3 is a flow chart depicting a method in accordance with an embodiment of the invention. The method may be performed, for example, on a computer or set of connected computers linked to the Internet. The method as depicted includes six steps.

In a first step 302, customer data relating to customers who purchased the consumer electronics product is retrieved from a customer database. The customer data may include, for example, customer profiles and data on related products already owned by the customer.

In a second step 304, life-cycle events based on a life cycle for the consumer electronics product are retrieved from an event database. The life-cycle events may include, for example, events that depend on ownership of one or more related product, events that depend on supplies for the product, or events related to commonly encountered support issues for the product or that specifically arise when using the product in conjunction with the related product. For instance, in the case of a printer, an early life-cycle event may comprise needing a first replacement ink/toner cartridge or a later life-cycle event may comprise of wanting a new/upgraded printer. In another instance, in the case of a scanner, a life-cycle event may comprise wanting to automatically separate text data from a scan for manipulation of the text data. In yet another instance, in the case of a digital camera, an early life-cycle event may comprise wanting a way to print or edit digital photographs.

In a third step 306, using the customer data retrieved in step 302 and the life-cycle events retrieved in step 304, the timing for sending electronic mail messages are determined. Electronic mail messages may be sent at times in the life cycle of the product when the customer is more receptive to the messages. For example, electronic mail messages including information about related products usable in cooperation with the product may be sent at times in the life cycle of the product when the customer is deemed ready to use the related products and hence likely to be receptive to the messages. Electronic mail messages about commonly encountered support issues may also be sent at times in the life cycle of the product when the customer is likely to encounter the support issues. Commonly encountered support issues may also include those that specifically arise when using the product in conjunction with a related product.

In a fourth step 308, content correlated to the life-cycle events for the consumer electronics product is retrieved. The content may include, for example, information about related products usable in cooperation with the product at times in the life cycle of the product when the customer is deemed ready to use the related product, information on commonly encountered support issues when such issues are likely to arise, or information on commonly encountered support issues that specifically arise when using the product in conjunction with a related product when such issues are likely to arise. For instance, in the case of a printer, the content may include information on avenues for purchasing replacement ink/toner cartridges when the customer is likely to need a first replacement ink/toner cartridge or information on avenues for purchasing a new/upgraded printer when the customer is likely to want a new/upgraded customer. In another instance, in the case of a scanner, the content may include information on how to obtain software to do the automatic separation of text data when the customer is likely to want to automatically separate text data from a scan for manipulation of the text data. In yet another instance, in the case of a digital camera, the content may include information on avenues for printing the photographs when the customer is likely to want a way to print photographs or information offering software to edit digital photographs when the customer is likely to want to edit photographs.

In a fifth step 310, message content for electronic mail messages to customers are personalized using the customer data retrieved in step 302 and the content correlated to the life-cycle event retrieved in step 308. The personalized message content may include, for example, information about related products that are usable in cooperation with the product purchased by the customer, information on how to use the product, or information on commonly encountered support issues.

In a sixth step 312, electronic mail messages containing the message content as personalized in step 310 are sent to the customers who purchased the product. For example, electronic mail messages including information about related products that are usable in cooperation with the product may be sent to the customer at times in the life cycle of the product when the customer is deemed ready to use the related product. Another example is that electronic mail messages including information about commonly encountered support issues for the product may be sent to the customer at times in the life cycle of the product when the customer is likely to encounter the support issues. A further example is that electronic mail messages including information about commonly encountered support issues that specifically arise when using the product in conjunction with a related product may be sent to a customer whose customer data indicates that the customer is using the related product in conjunction with the product, when the customer is likely to encounter the support issue.

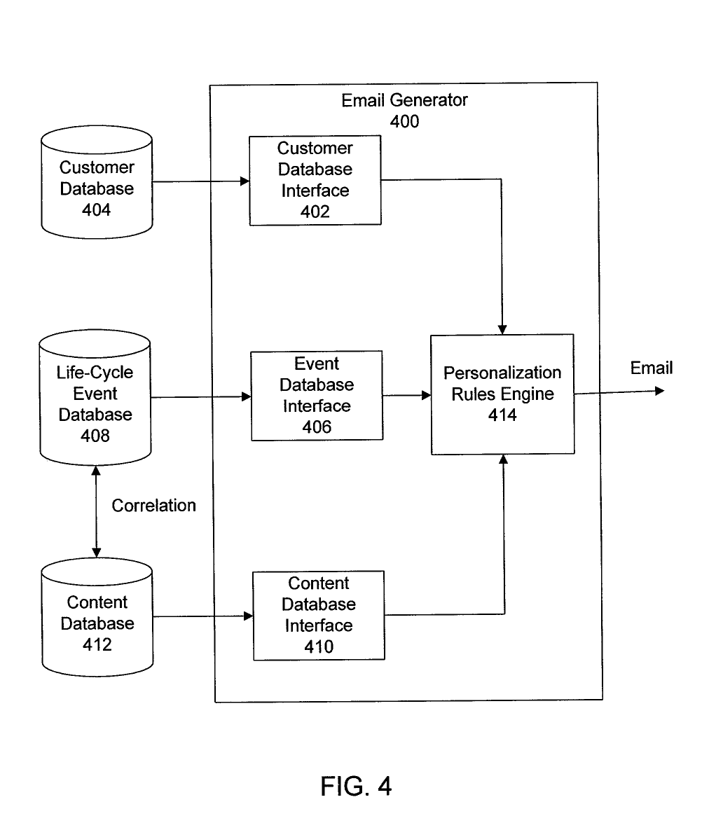

FIG. 4 is a diagram depicting an apparatus in accordance with an embodiment of the invention. The email generator 400 in this embodiment is coupled to a customer database 404, a life-cycle event database 408, and a content database 412. The customer database 404, life-cycle event database 408 and content database 412 may, for example, be located on different computers or systems than the email generator 400. The email generator 400 may be located on one computer or a system of interconnected computers. The email generator may be connected, for example, to the Internet or other means for sending electronic mail messages.

The email generator 400 is connected via a customer database interface 402 to a customer database 404 to provide customer data relating to customers who purchased the product. The customer data in customer database 404 may include, for example, customer profiles and data on related products already owned by the customer.

The email generator 400 is coupled via an event database interface 406 with a life-cycle event database 408 to provide life-cycle events based on the life cycle of the product. The life-cycle events in the life-cycle event database 408 may include, for example, events that are dependent on owning one or more related products, events that depend on supplies for the product, or events related to commonly encountered support issues for the product or that specifically arise when using the product in conjunction with the product. For instance, in the case of a printer, the life-cycle event in the life-cycle event database 408 may include the early life-cycle event of needing a first replacement of an ink/toner cartridge or a later life-cycle event of wanting a new/upgraded printer. In another instance, in the case of a scanner, the life-cycle event in the life-cycle event database 408 may include wanting to automatically separate text data from a scan for manipulation of the text data. In a third instance, in the case of a digital camera, the life-cycle event in the life-cycle event database 408 may include wanting a way to print or edit photographs.

The email generator 400 is connected via a content database interface 410 with a content database 412 to provide content correlated to the life-cycle events contained in the life-cycle event database 408. The content in the content database 412 may include, for example, information about related products that are usable in cooperation with the product correlated with the times in the life cycle of the product when the customer is deemed ready to use the related product, information on commonly encountered support issues correlated to when such issues are likely to arise, or information on commonly encountered support issues that specifically arise when using the product in conjunction with a related product correlated to when such issues are likely to arise. For instance, in the case of a printer, the content in the content database 412 may include information on avenues for purchasing replacement ink/toner cartridges correlated with the early life-cycle event of needing a first replacement ink/toner cartridge contained in life-cycle event database 408 or information on avenues for purchasing a new/upgraded printer correlated with the later life-cycle event of wanting a new/upgraded printer contained in life-cycle event database 408. In another instance, in the case of a scanner, the content in the content database 412 may include information on obtaining software to do the automatic separation of the text data correlated with the life-cycle event of wanting to automatically separating text data from a scan for manipulation of the text data, contained in the life-cycle event database 408. In yet another instance, in the case of a digital camera, the content in the content database 412 may include information on avenues for printing photographs correlated with the life-cycle event of wanting to print photographs contained in the life-cycle event database 408 or information on offerings of software to edit digital photographs correlated with the life-cycle event of wanting to edit photographs contained in the life-cycle event database 408.

As part of the email generator 400, a personalization rules engine 414 is coupled to the customer database 404 via the customer database interface 402, to the life-cycle event database 408 via the event database interface 406, and to the content database 412 via the content database interface 410 in order to create electronic mail messages to send to the customers who purchased the product. The electronic mail messages generated by the email generator 400 may include information, for example, about related products that are usable in cooperation with the product or about commonly encountered support issues related to the product or specifically arising when using the product in conjunction with a related product.

The timing for sending the electronic mail messages is determined using the customer data from the customer database 404 and life-cycle event database 408. The electronic mail messages are sent at times in the life cycle of the product when the customer is likely to be receptive to the messages. For example, information about related products usable in cooperation with the product are included in electronic mail messages that are sent at times in the life cycle of the product when the customer is deemed ready to use the related products and hence likely to be receptive to the messages or information about commonly encountered support issues for the product are included in electronic mail messages that are sent at times in the life cycle when the customer is likely to encounter the support issues.

The personalization rules engine 414 personalizes the message content for the electronic mail messages using the customer data from the customer database 404 and the content from the content database 412 correlated with the life-cycle events contained in the life-cycle event database 408. The email generator 400 then sends the electronic mail messages with content personalized by the personalization rules engine 414.

In one embodiment of the invention, the personalization may be dependent on factors such as a consumer type, a level of user, and a country or region of use. The consumer type may be, for example, a home consumer or a corporate consumer. For instance, the email message may be of a different style and with different emphasis for home versus corporate consumers. The level of user may, for example, range from beginner, to intermediate, to advanced, to expert. For instance, the level of detail in the email message may vary depending on the user level. The country or region of use may, for example, be the United States or Japan or another country. As another example, metropolitan versus suburban regions may be differentiated. For instance, the language or content of the email messages may vary depending on the country or region of the consumer.

The above-described database interfaces (402, 406, and 410) may be implemented, for example, using structured query language (SQL) queries to the database. The above-described databases (404, 408, and 412) may be implemented, for example, using a commercially available relational database system.

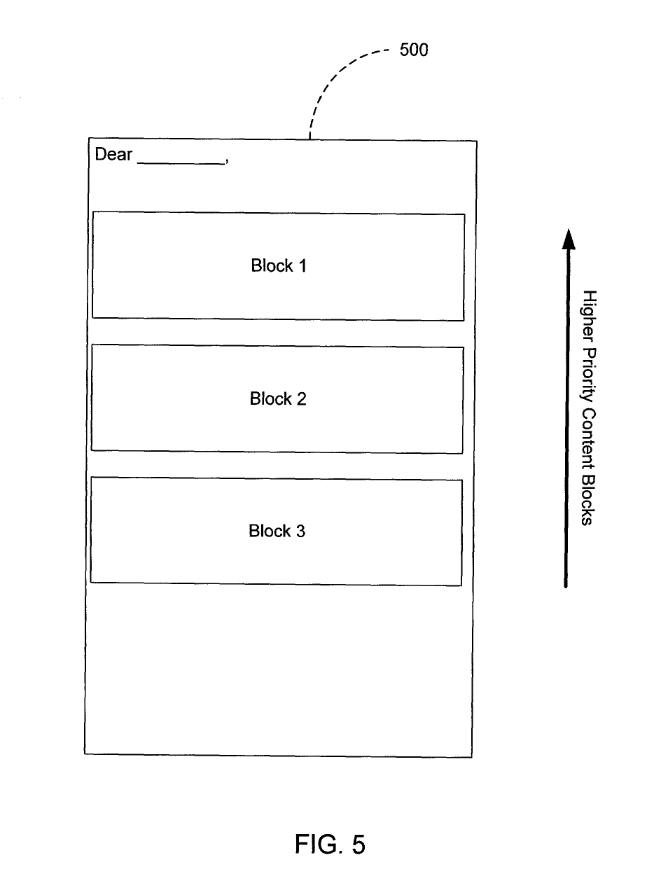

FIG. 5 is an illustration showing a generated electronic mail message in accordance with an embodiment of the invention. The email message 500 is a personalized one directed to a particular customer and generated by the personalization rules engine 414 of FIG. 4. The email message 500 may have blocks of content (block 1, block 2, and block 3 are illustrated as examples). In one embodiment, these content blocks may be prioritized by the personalization rules engine 414. The email message 500 may be constructed such that the higher priority content blocks appear closer to the beginning of the message 500 and the lower priority content blocks appear closer to the end of the message 500. Content blocks of higher priority may, for example, include content that is of more urgent timeliness or that is more likely to be of interest to the particular customer.

In the above description, numerous specific details are given to provide a thorough understanding of embodiments of the invention. However, the above description of illustrated embodiments of the invention is not intended to be exhaustive or to limit the invention to the precise forms disclosed. One skilled in the relevant art will recognize that the invention can be practiced without one or more of the specific details, or with other methods, components, etc. In other instances, well-known structures or operations are not shown or described in detail to avoid obscuring aspects of the invention. While specific embodiments of, and examples for, the invention are described herein for illustrative purposes, various equivalent modifications are possible within the scope of the invention, as those skilled in the relevant art will recognize.

These modifications can be made to the invention in light of the above detailed description. The terms used in the following claims should not be construed to limit the invention to the specific embodiments disclosed in the specification and the claims. Rather, the scope of the invention is to be determined by the following claims, which are to be construed in accordance with established doctrines of claim interpretation.

What is claimed is:

1. An apparatus for generating life-cycle-based pre-emptive electronic mail relating to a consumer electronic product, the apparatus comprising:
a customer database interface for providing customer data relating to customers who purchased the product;
an event database interface for providing life-cycle events based on a life-cycle for the product;
a content database interface for providing content correlated to the life-cycle events for the product; and
a generation engine coupled to the customer, event, and content databases for creating electronic mail messages to send to the customers who purchased the product,
wherein timing for sending the electronic mail messages is determined using the customer data from the customer database and the life-cycle events from the event database, and
wherein message content for the electronic mail messages is personalized for a customer using the customer data from the customer database and the content from the content database.

2. The apparatus of claim 1,
wherein the customer data from the customer database includes customer profiles and data on related products already owned by the customer, and
wherein the life-cycle events from the event database include events that are dependent on ownership of more than one related product.

3. The apparatus of claim 1,
wherein the electronic mail messages includes information about related products that are usable in cooperation with the product, and
wherein the electronic mail messages are sent at times in the life cycle of the product when the customer is deemed ready to use the related products and hence likely to be receptive to the messages.

4. The apparatus of claim 3,
wherein the product comprises a printer,
wherein an early life-cycle event comprises needing a first replacement ink/toner cartridge, and
wherein the content associated with that early life-cycle event comprises information on avenues for purchasing replacement ink/toner cartridges.

5. The apparatus of claim 4,
wherein a later life-cycle event comprises wanting a new/upgraded printer, and
wherein the content associated with that later life-cycle event comprises information on avenues for purchasing the new/upgraded printer.

6. The apparatus of claim 5,
wherein the product comprises a scanner,
wherein a life-cycle event comprises wanting to automatically separate text data from a scan for manipulation of the text data, and
wherein the content associated with the life-cycle event comprises information on obtaining software to do the automatic separation of the text data.

7. The apparatus of claim 3,
wherein the product comprises a digital camera,
wherein an early life-cycle event comprises wanting a way to print photographs taken by the digital camera, and
wherein the content associated with that early life-cycle event comprises information on avenues for printing the photographs taken by the digital camera.

8. The apparatus of claim 7,
wherein another life-cycle event comprises wanting to edit photographs taken by the digital camera, and
wherein the content associated with that life-cycle event comprises an offering of software to edit digital photographs.

9. The apparatus of claim 1,
wherein the electronic mail messages includes information about commonly encountered support issues for the product, and
wherein the electronic mail messages are sent at times in the life cycle of the product when the customer is likely to encounter the support issues.

10. The apparatus of claim 9,
wherein the customer data from the customer database includes data on a related product owned by the customer that is used in conjunction with the product, and
wherein the commonly encountered support issues include those that specifically arise when using the product in conjunction with the related product.

11. A method for generating life-cycle-based pre-emptive electronic mail relating to a consumer electronic product, the method comprising:
retrieving customer data relating to customers who purchased the product;
retrieving life-cycle events based on a life cycle for the product;
determining timing for sending the electronic mail messages using the customer data and the life-cycle events, and
retrieving content correlated to the life-cycle events for the product;
personalizing message content for electronic mail messages to customers using the customer data and the content correlated to the life-cycle events; and
sending the electronic mail messages to the customers who purchased the product.

12. The method of claim 11,
wherein the customer data from the customer database includes customer profiles and data on related products already owned by the customer, and
wherein the life-cycle events from the event database include events that are dependent on ownership of more than one related product.

13. The method of claim 11,
wherein the electronic mail messages includes information about related products that are usable in cooperation with the product, and
wherein the electronic mail messages are sent at times in the life cycle of the product when the customer is deemed ready to use the related products and hence likely to be receptive to the messages.

14. The method of claim 13,
wherein the product comprises a printer,
wherein an early life-cycle event comprises needing a first replacement ink/toner cartridge, and
wherein the content associated with that early life-cycle event comprises information on avenues for purchasing replacement ink/toner cartridges.

15. The method of claim 14,
wherein a later life-cycle event comprises wanting a new/upgraded printer, and
wherein the content associated with that later life-cycle event comprises information on avenues for purchasing the new/upgraded printer.

16. The method of claim 15,
wherein the product comprises a scanner,
wherein a life-cycle event comprises wanting to automatically separate text data from a scan for manipulation of the text data, and
wherein the content associated with the life-cycle event comprises information on obtaining software to do the automatic separation of the text data.

17. The method of claim 13,
wherein the product comprises a digital camera,
wherein an early life-cycle event comprises wanting a way to print photographs taken by the digital camera, and
wherein the content associated with that early life-cycle event comprises information on avenues for printing the photographs taken by the digital camera.

18. The method of claim 17,
wherein another life-cycle event comprises wanting to edit photographs taken by the digital camera, and
wherein the content associated with that life-cycle event comprises an offering of software to edit digital photographs.

19. The method of claim 11,
wherein the electronic mail messages includes information about commonly encountered support issues for the product, and
wherein the electronic mail messages are sent at times in the life cycle of the product when the customer is likely to encounter the support issues.

20. The method of claim 19,
wherein the customer data from the customer database includes data on a related product owned by the customer that is used in conjunction with the product, and
wherein the commonly encountered support issues include those that specifically arise when using the product in conjunction with the related product.

21. A system for generating life-cycle-based pre-emptive electronic mail relating to a consumer electronic product, the system comprising:
means for retrieving customer data relating to customers who purchased the product;
means for retrieving life-cycle events based on a life-cycle for the product;
means for determining timing for sending the electronic mail messages using the customer data and the life-cycle events, and
means for retrieving content correlated to the life-cycle events for the product;
means for personalizing message content for electronic mail messages to customers using the customer data and the content correlated to the life-cycle events; and
means for sending the electronic mail messages to send to the customers who purchased the product.
